(19) United States
(12) Patent Application Publication
(10) Pub. No.: US 2006/0100976 A1
(43) Pub. Date: May 11, 2006

(54) Method for searching image files

(75) Inventor: Wei-Ting Hsieh, Tainan City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Ulead Systems, Inc.

(21) Appl. No.: 10/973,591

(22) Filed: Oct. 26, 2004

(51) Int. Cl. G06F 17/30

(52) U.S. Cl. 707/1

(57) ABSTRACT

The present invention discloses the method for searching pictures which are stored in digital format as image files, especially as image files in Exif (exchangeable image file) format. With the method, the user can search certain pictures which are taken on specific holidays or anniversaries in a convenient and efficient way. The method comprises retrieving data of the files; selecting a date without a particular year; searching the files for desired files which are created on that date in every year according to the data; and listing the desired files; wherein the data are established while the files are created, and the data are unchangeable in a normal transferring process, such as copying, moving, or editing.

### FIELD OF THE INVENTION

The present invention relates to a method for searching image files, especially to a method for searching the Exif image files which are created on specific date in each possible year.

### BACKGROUND OF THE INVENTION

In recent years, the digital camera has become a popular device all around the world. With the digital camera, users could capture pictures in a more convenient and inexpensive way. The pictures are stored in the digital format as image files. Generally, the capacity of the traditional film is able to take merely twenty-four or thirty-six pictures, but the memory cards used in digital cameras can save hundreds of images varied with their capacity. Therefore, more and more images would be kept because of the raising of the capacity of storing means such as memory cards, the hard disc, and even the writable disc such as compact disc (CD) or digital video disc (DVD).

As hundreds or even thousands of images are kept in certain storing means mentioned above, the management of the great amount of image files would turn into a complicated and difficult task. The conventional way used to search or sort files normally bases on their file names, file sizes, last-modified time, or file types. For example, Windows operation system of Microsoft provides such conventional way to sort the files in certain folder and to search for specific files in designated place (Windows® and Microsoft® used herein are both registered trademarks of Microsoft Corporation). However, image files are very special files since they usually have meaningful significance to the users, and the content of the image files is different from that of text files. Therefore, one cannot search or sort the image files according to particular key words.

The initial file names of image files are usually created by the digital image device such as a digital camera or a scanner, and the automatically created file names are meaningless to the users. Hence, searching or sorting according to those file names is also insignificant. If the users desire to manage the large number of image files, the alternative way is to rename every image file depending on the features or persons in the image, the place where the image was taken at, or the date when the image was taken on. Accordingly, the new image names may possess some significance to the users. Nevertheless, it is tiresome to rename all image files since the number of image files stored in the memory cards may be quite large.

Besides, holidays and anniversaries are always important and meaningful to the users. In these special days, people may have chances to make tours or get together, and the pictures taken in that time would be more meaningful to the users. But, the date information of the image files in traditional operation systems merely represents the last modified date instead of the creation date, on which the image file was taken. The last modified date is often different from the creation date, so searching or sorting by the last modified date is meaningless. Therefore, with available systems and methods, the users cannot search and sort image files that taken in certain special holidays or anniversaries.

### SUMMARY OF THE INVENTION

In view of the problems mentioned above, the present invention thus provides the methods for searching files. With the methods of the present invention, the users may search for desired files which are created on specific date in every possible year. For example, the users may search all pictures which are taken on Christmas Days of every year. Since the holidays, anniversaries, or other specific days have meaningful significance to the users, the users may have desire to search the pictures which are taken in these special days.

One purpose of the present invention is to provide a method for searching files, which comprises retrieving data of the files, and selecting a date without a particular year, that is, a month and a day. Next, the files are searched for desired files which are created on that date in every possible year according to the data thereof, and then the desired files are listed. The data are established while the files are created, and the data are unchangeable during the normal transferring process of the files. The date may be selected from predetermined holidays or anniversaries, and the files may be the image files in Exif (exchangeable image file) format.

Another purpose of the present invention is to provide a computer-readable storage medium having computer-executable instructions for searching files by performing the following, comprising retrieving data of files stored in storing means; selecting a date without a particular year, that is, a month and a day; searching the files for desired files which are created on that date in every possible year according to the data thereof; and listing the desired files. The data are established while these files are created, and the data are unchangeable during the transferring process of the files. The files may be image files in Exif (exchangeable image file) format, and the data may comprise attribute information used in Exif format.

Yet another purpose of the present invention is to provide a method for searching image files in Exif format, which comprises retrieving attribute information of the image files, and selecting a date without a particular year, that is, a month and a day. Next, the files are searched for desired files which are created on that date in every possible year according to the attribute information thereof, and then the desired files are listed. The attribute information is unchangeable during the normal transferring process of the image files, and the date may be selected from predetermined holidays or anniversaries.

Still another purpose of the present invention is to provide a system for searching files, which comprises: a processor and an image pickup device coupled to said processor, wherein the image pickup device is capable of capturing an image and converting an analog image signal into a digital image signal. Storage is coupled to the processor for storing files. A displayer is coupled to the processor, wherein the displayer allows displaying a user interface for a user to select a month and a day. A searching module is coupled to the processor and the storage, wherein the data of files are retrieved from the storage, and the searching module searches the files for desired files which are created on that month and that day according to the input instruction or data by the user.

### BRIEF DESCRIPTION OF THE DRAWINGS

FIG. 1 is the flow chart presenting one embodiment of the present invention.

FIG. 2 is a block diagram of the computer-readable storage medium according to the present invention.

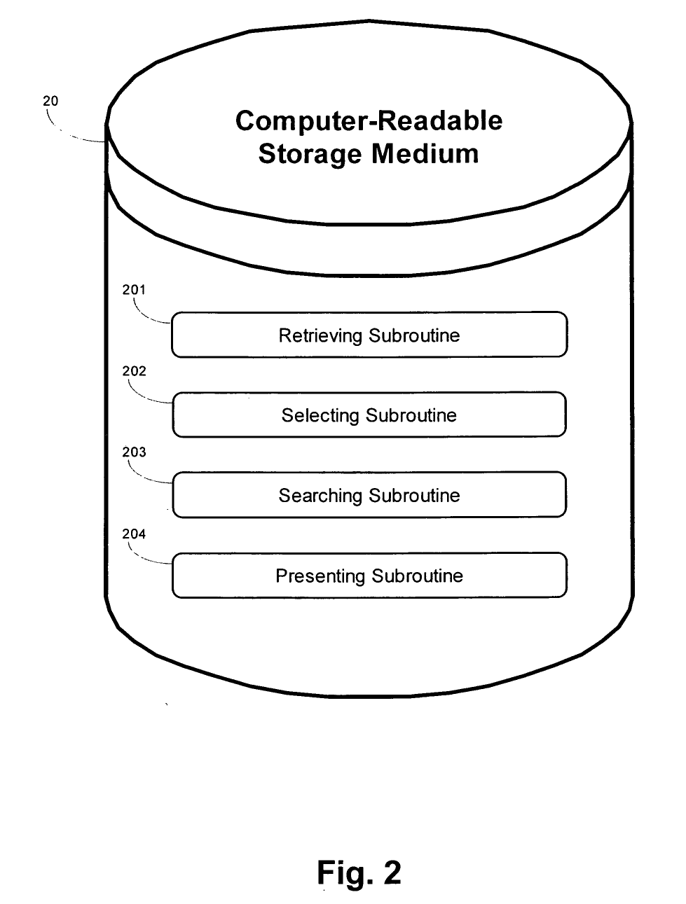

FIG. 3 is the flow chart presenting another embodiment of the present invention.

FIG. 4 is a block diagram of the system according to the present invention.

### DETAILED DESCRIPTION OF THE PREFERRED EMBODIMENT

Referring now to the drawings wherein the showings are for the purpose of illustrating the preferred embodiments of the present invention only, and not for the purpose of limiting same.

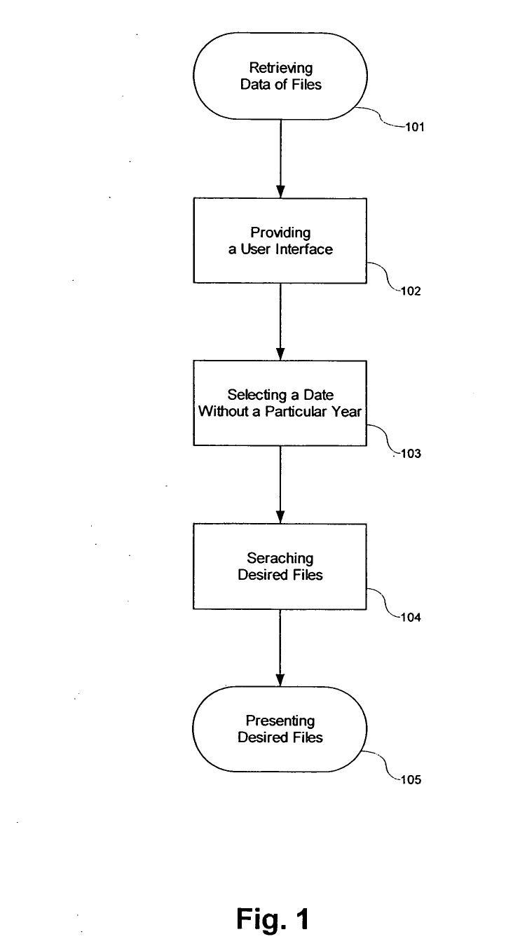

According to one aspect of the present invention, a method for searching files is disclosed. Plural files are stored in some storing devices, such as a hard disc, a compact disc, a digital video disc, a floppy, memory, and the like. In one embodiment of the present invention, these files have some data code recording certain information of the files, and the data code are unchangeable during a normal transferring process of the files, such as copying, moving, and editing. With this kind of data code or parameters, a user can utilize the original information of the files to search some special files. In step 101 of FIG. 1, the data are retrieved from the files stored in the storing device by the instruction input by the user from, for example, the interface of the digital camera or computer coupled thereto. Next, in step 102, a user interface is generated or provided by the device such as DV, digital camera or computer, and the user interface may allow the user to input the searching instruction by selecting a date code without particular year in step 103, that is, such a date code may includes a month code and a day code. In one embodiment of the present invention, the date may be any date or a predetermined holiday or anniversary. For example, the holyday can be selected from New Year's Day, New Year' Eve, Easter, Thanksgiving Day, and Christmas Day, and the anniversary can be the wedding anniversary or the anniversary of graduation. Besides, the date may be the birthday of one's parents, spouse, children, etc.

After the date is selected, the present invention may perform a searching procedure according to the parameters set by the user for the desired files which are originally created on the selected date in step 104. Since the data code represent the initial information of the files, the desired files would be found out according to the data code thereof. In one embodiment of the present invention, the file may be an image file in Exif (exchangeable image file) format, and the data code or parameter comprises the attribute information used in Exif format. The attribute information includes the date tags, which can be used as the searching basis for creation date. It should be appreciated that the files may be in any format which is capable of recording certain constant information. Exif format is merely one example for illustrating the embodiment of the present invention, and is not used for limiting the present invention.

The desired files then would be determined and presented in step 105 by the method of the present invention. In the preferred embodiment of the present invention, the desired files may be shown or listed in the user interface of the aforementioned device. Alternatively, the desired files may be shown or listed by other devices, such as being input into a projector, followed by projecting the desired file on a screen, being displayed on the same or different displayer, or even being input into a printer and printed out. It should be appreciated that the way to present the desired files are varied depending on the user's demand, and the mentioned ways are merely recited for illustration but not for limitation. Through the steps above, the user is able to search for desired pictures in digital format as image files, which are taken in some special date in every possible year, from a quite large number of image files in a convenient and efficient method.

According to another aspect of the present invention, a computer-readable storage medium 20 having computer-executable instructions is disclosed. In one embodiment of the present invention, the computer-executable instructions may comprise the retrieving subroutine 201, the selecting subroutine 202, the searching subroutine 203, and presenting subroutine 204. These instructions are applied for searching specific files by performing some steps.

There are plural files stored in some storing devices, such as a hard disc, a compact disc, a digital video disc, a floppy, memory, and so forth. In the preferred embodiment of the present invention, these files have some data code recording certain information of the files. As aforementioned, the data codes are unchangeable. To search some special files is likely by means of the data code. The data code is retrieved from the files by retrieving subroutine 201. Next, a user interface is provided and allows the user to select a date without particular year by selecting subroutine 202.

The presenting subroutine 204 would subsequently list or display the desired files. In the preferred embodiment of the present invention, the desired files may be listed or shown in the user interface. Alternatively, the desired files may be listed or shown by other device as aforementioned. According to the present invention, the user could search for desired pictures in digital format as image files from a quite large number of image files.

In the preferred embodiment of the present invention, the computer-readable storage medium may comprise a floppy disc, a compact disc, a hard disc, a digital video disc (DVD), or memory. It should be appreciated that the types of computer-readable storage medium are various. The examples are merely recited for illustration instead of limitation.

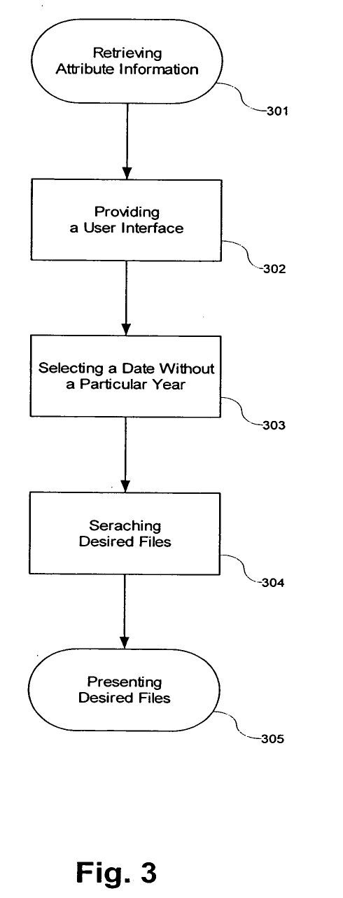

According to yet another aspect of the present invention, a method for searching image files in Exif format is disclosed. Please refer to FIG. 3, the main procedures of the embodiment are similar to the embodiment of FIG. 1, except the parameters that being retrieved. In step 301 of FIG. 3, the attribute information is retrieved from the Exif image files. Next, the attribute information is fed to a user interface which is provided in step 302, and the user interface may allow the user to select a date without particular year in step 303. The date may be any date as mentioned in the example of FIG. 1. After the date is selected, in step 304, the system will be in responsive to the selected input signal to search the desired files which are originally created on the selected date. Since the attribute information represents the original information of the files, the desired image files would be found out according to the attribute information thereof. The attribute information may include the date tags, which can be used as the searching basis for creation date.

The desired image files then would be presented in step 305. In the preferred embodiment of the present invention, the desired files may be listed or shown in the user interface. Alternatively, the desired files may be listed or shown by other means as mentioned above.

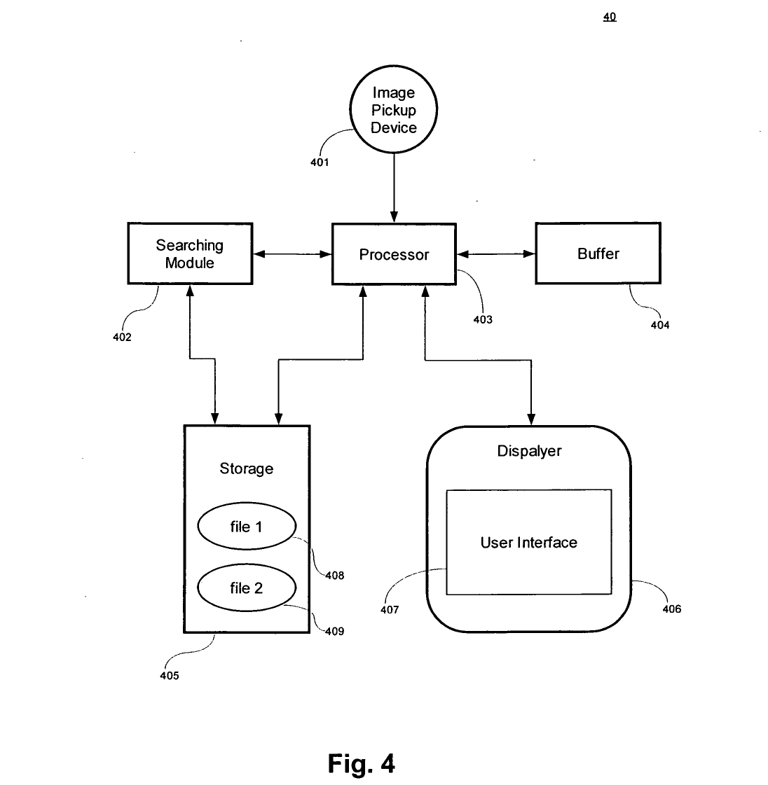

In order to achieve the purpose of the present invention, the system of the present invention is illustrated in FIG. 4. The system 40 comprises an image pickup device 401, a searching module 402, a processor 403, storage 405, and a displayer 406. The system may further comprise a buffer 404 that is coupled to the processor 403, and the buffer 404 is used to temporally store data code of the files. The type of buffer 404 may be flash memory or random access memory (RAM). The displayer 406 is coupled to the processor 403 and enables the user to select a date without a particular year, that is, a month and a day. The storage 405 is coupled to the processor 403 and the searching module 402. As in FIG. 4, two files 408 and 409 are stored in the storage 405 for example, but the number of the files is varied only if the capacitor of the storage 405 is not exceeded. The date code of the files are retrieved from the files in the storage 405 by the processor 403 or the searching module 402, and such data are unchangeable in normal transferring process of the files. In the preferred embodiment of the present invention, the files may be image files in Exif format, and the data may be the attribute information used in Exif format.

The displayer 406 may display a user interface 407. Through the user interface 407 the user is allowed to select a date without a particular year, that is, a month and a day. As mentioned above, the date may be any date or selected from predetermined holidays or anniversaries.

In the preferred embodiment of the present invention, the searching module 402 of the system is an application or software with executable instructions for searching desire files according the unchangeable data of the files, and stored in a storage medium coupled to the processor 403. The processor 403 implements the instructions in the searching module 402. Alternatively, the searching module 402 may be a subsystem which comprises a searching processor, a searching buffer, and searching subroutines. After the date code is set, the searching module 402 would search the files for desired files which are created on the date in every possible year. Since the data are unchangeable, the information therein should represent the original attribute of the files. Therefore, the user can search for desired files on the basis of creation date instead of last modified date. The desired files then may be listed on the displayer 404.

The displayer 404 may comprise a LCD (liquid crystal display), a PDP (Plasma Display Panel), a CRT monitor, a television, a projector and so on. Besides, the image pickup device 401 is coupled to the processor 403 and typically, the image pickup device 401 may comprise lens, a CCD, and an AD converter. As well-known in the art, the image pickup device 401 could catch the image signal and subsequently convert an optical analog image signal into a digital signal, and storing the image in digital format as an image file. Some of the files stored in the storage 405 may be captured by the image pickup device 401. The system 40 may be a digital still camera, a digital video camera, or a mobile phone (incorporated with a digital still camera) with the function of searching desired files. Moreover, a computer having a web camera and the searching module should be included in the present invention.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A method for searching files in storage, which comprises:
retrieving data of said files from said storage;
inputting a searching instruction by selecting a month and a day; and
searching a desired file which is created on said month and said day in every year according to said input instruction; wherein said data are established while said files are created, and said data are unchangeable in a transferring process of said files.

2. The method as set forth in claim 1, wherein said files are image files in Exif (exchangeable image file) format, and wherein said data comprise attribute information in said Exif format.

3. The method as set forth in claim 1, wherein said month and said day are selected from predetermined holidays or anniversaries.

4. The method as set forth in claim 1, which further comprises:
providing a user interface for a user to select said month and said day before inputting said searching instruction.

5. The method as set forth in claim 4, which further comprise:
listing said desired file on said user interface after said step of searching said desired file.

6. A computer-readable storage medium having computer-executable instructions for searching files by performing the following, comprising:
retrieving data of said files in a storing device;
inputting a searching instruction by selecting a month and a day; and
searching said files for a desired file which is created on said month and said day in every year according to said searching instruction;
wherein said data are established as said files are created, and said data are unchangeable in a transferring process of said files.

7. The computer-readable storage medium as set forth in claim 6, wherein said files are image files in Exif (exchangeable image file) format, and wherein said data comprise attribute information in said Exif format.

8. The computer-readable storage medium as set forth in claim 6, wherein said month and said day are selected from predetermined holidays or anniversaries.

9. The computer-readable storage medium as set forth in claim 6, wherein said storage medium comprises a floppy disc.

10. The computer-readable storage medium as set forth in claim 6, wherein said storage medium comprises a compact disc (CD).

11. The computer-readable storage medium as set forth in claim 6, wherein said storage medium comprises a hard disc (HD).

12. The computer-readable storage medium as set forth in claim 6, wherein said storage medium comprises a digital video disc (DVD).

13. The computer-readable storage medium as set forth in claim 6, wherein said storage medium comprises memory.

14. A method for searching image files in Exif (exchangeable image file) format in storage, which comprises:
retrieving attribute information of said image files in said storage, wherein said attribute information is recorded in accordance with said Exif format;
inputting a searching instruction by selecting a month and a day; and
searching said image files for desired files which are created on said month and said day in every year according to said attribute information thereof.

15. The method as set forth in claim 14, which further comprises a step of providing a user interface for a user to select said month and said day before inputting said searching instruction.

16. The method as set forth in claim 15, wherein said image files are listed on said user interface after said step of searching said desired files.

17. The method as set forth in claim 16, wherein said attribute information is unchangeable in a transferring process of said image files.

18. The method as set forth in claim 16, wherein said month and said day are selected from predetermined holidays or anniversaries.

19. A system capable of searching files in storage, which comprises:
a processor;
an image pickup device coupled to said processor capable of capturing an optical image signal and converting said optical image signal into an digital signal;
storage coupled to said processor for storing said files;
a displayer allowing to display a user interface coupled to said processor, wherein said user interface allows a user to select a month and a day; and
a searching module coupled to said processor and said storage wherein said searching module is in responsive to said processor to search a desired file which are created on at least one of said month and said day according to data of said files that are retrieved from said storage.

20. The system as set forth in claim 21, wherein said files are image files in Exif (exchangeable image file) format, and said data comprising attribute information in said Exif format.

21. The system as set forth in claim 21, wherein said month and said day are selected from predetermined holidays or anniversaries.

22. The system as set forth in claim 21, which further comprises:
a buffer coupled to said processor for temporally storing said data.
